(19) United States
(12) Patent Application Publication
(10) Pub. No.: US 2019/0225807 A1
(43) Pub. Date: Jul. 25, 2019

(54) ASPHALT MIX SUITABLE FOR INTEGRATING A HEAT EXCHANGER DEVICE

(71) Applicant: EUROVIA, RUEIL MALMAISON (FR)

(72) Inventors: Stéphane FAUCON-DUMONT, MARTIGNAS SUR JALLES (FR); Thomas GIANETTI, BORDEAUX (FR); Florian PIRAUD, LE HAILLAN (FR)

(73) Assignee: EUROVIA, RUEIL MALMAISON (FR)

(21) Appl. No.: 16/336,306

(22) PCT Filed: Sep. 26, 2017
(86) PCT No.: PCT/FR2017/052587

§ 371 Date: Mar. 25, 2019

(30) Foreign Application Priority Data
Sep. 26, 2016 (FR) 1659055

(51) Int. Cl. C08L 95/00

(52) U.S. Cl. CPC C08L 95/00; C08L 2555/64; C08L 2555/26; C08K 2201/005

(57) ABSTRACT

The present invention relates to hot or warm asphalt mix comprising a granular fraction and a hydrocarbon-based binder, characterised in that the elements of the granular fraction have dimensions between 0 mm and 10 mm, and in that the hydrocarbon-based binder comprises a workability additive, having a melting point above 60° C. and below 130° C., said asphalt mix being resistant to rutting, compact and workable, with a workability, measured with a Nynas workability meter at the working temperature of the asphalt mix, of less than 350N and insulating with a thermal conductivity, λ, of less than 1 W/m·K.

It also relates to a road surfacing, in particular comprising an integration layer based on the asphalt mix comprising pipes of a heat exchanger device.

It finally relates to a method for preparing such a road surfacing.

The invention relates to an asphalt mix that is workable, compact, resistant to rutting and insulating. This asphalt mix is particularly suited to integrating a heat exchanger device aiming to heat the roadway.

Approximately 32 million kilometres of surfaced roads exist in the world. Roadways are more or less flat surfaces, generally of dark colour, which makes them interesting for this invention: their thermal properties mean that they are capable of storing up notable amounts of thermal energy during the day, thanks to the amount of sunshine received. In a global context of development of renewable energies, it seems to make very good sense to recover this free energy captured by roadways.

Among the different materials used for the construction of roadways, in particular poured asphalt, asphalt mix, concrete, macadam or sand, asphalt mix is one of the materials that rises the most in temperature in the course of the day on account of their lower reflectivity and their moderate thermal conductivity.

An asphalt mix is a mixture of a granular fraction, comprising aggregates and sand, and hydrocarbon-based binder applied as one or more layers to constitute the roadway of roads.

Hot asphalt mix is manufactured hot (generally from 130° C. to 170° C.) and applied hot (generally from 110° C. to 160° C.).

Warm asphalt mix meet all the specifications of hot asphalt mixes, but are produced and implemented at a temperature of 30° C. to 60° C. lower compared to hot asphalt mixes. Thus, warm asphalt mix is manufactured at temperatures ranging from 100° C. to 140° C. and applied at temperatures ranging from 80° C. to 130° C.

The hot or warm asphalt mix is deposited by spreading, for example with a paver or a grader, then compacted.

The invention aims to propose an asphalt mix optimised for the incorporation of pipes of a heat exchanger device.

This asphalt mix must be able to limit void spaces around the pipes, to protect the pipes without damaging them, and to support thereafter site machinery then all traffic, in particular heavy traffic.

The invention relates to hot or warm asphalt mix comprising a granular fraction and a hydrocarbon-based binder, characterised in that the elements of the granular fraction have dimensions between 0 mm and 10 mm, and in that the hydrocarbon-based binder comprises a workability additive, having a melting point above 60° C. and below 130° C., said asphalt mix being resistant to rutting, compact and workable, with a workability, measured with a Nynas workability meter at the working temperature of the asphalt mix, of less than 350N and insulating with a thermal conductivity, λ, of less than 1 W/m·K.

The elements of the granular fraction of the asphalt mix have dimensions between 0 mm and 10 mm, advantageously between 0 mm and 6 mm.

It has been discovered that this low particle size makes it possible to improve the contact between the pipes and the asphalt mix.

“Solid mineral fractions” is here taken to mean all solid fractions that can be used for the production of asphalt mix notably for road construction, notably comprising natural mineral aggregates (gravel, sand, fines) from quarries or gravel pits, recycled products such as aggregates of asphalt mix resulting from the recycling of materials recovered during roadworks as well as surplus from asphalt mix units, production scrap, aggregates coming from the recycling of road materials including concretes, slags in particular clinkers, schists in particular bauxite or corundum, rubber crumbs notably derived from the recycling of tyres, artificial aggregates of any origin and coming for example from household waste incineration (HWI) slag, and mixtures thereof in all proportions.

Within the scope of the invention, the granular fraction advantageously comprises:
elements less than 0.063 mm (filler or fines);
sand, of which the elements are between 0.063 mm and 2 mm;
elements, in particular gravel, having dimensions:
between 2 mm and 6 mm;
optionally, between 6 mm and 10 mm;

The size of the mineral aggregates is measured by the tests described in the NF EN 933-2 Standard (version May 1996).

“Mineral fines” or “filler” is taken to mean any mineral or siliceous filler, passing through a 0.063 mm side square mesh sieve. The fines may be natural or added fines, for example limestone (calcium carbonate) fines, cement or hydrated lime fines, or recovered lime fines.

“Aggregates of asphalt mix” is taken to mean asphalt mix (mixture of aggregates and bituminous binders) coming from the milling of asphalt mix layers, the crushing of slabs extracted from asphalt mix treated roadways, bits of slabs of asphalt mixes, asphalt mix waste or asphalt mix production surplus (productions surpluses are materials coated or partially coated in asphalt mixing units resulting from transitory manufacturing phases).

In the granular fraction, the fines content (elements having a size less than or equal to 0.063 mm), advantageously varies from 4% to 15% by volume, compared to the total volume of the granular fraction.

In the granular fraction, the content of elements having a size greater than 0.063 mm and less than or equal to 2 mm, in particular sand, advantageously varies from 15% to 80% by volume, compared to the total volume of the granular fraction.

In the granular fraction, the content of elements having a size greater than 2 mm, advantageously up to 6 mm, varies from 5 to 81% by volume, compared to the total volume of the granular fraction.

Asphalt mix includes a binder. The binder is that which makes it possible to bind the aggregates together and to ensure good mechanical strength of the roadway. A binder may be bituminous or plant based or synthetic. The binder may also be a mixture of binders derived from these different origins.

“Binder” is taken to mean a hydrocarbon-based binder, advantageously of fossil origin, or any binder of plant or synthetic origin, which can be used for the production of an asphalt mix. Advantageously, it is any composition containing bitumen, a workability additive and optionally one or more additives and/or one or more emulsifiers and/or one or more viscosifiers and/or one or more fluxing agents and/or one or more plastifiers and/or any other additive making it possible to adjust the properties thereof, such as for example the adhesiveness. As an example, bitumens, bitumens modified by elastomers and/or plastomers may be cited.

Advantageously, the binder is 35/50 grade.

In an advantageous alternative of the invention, road binders meeting the NF EN 12591 (2009, pure bitumens) or NF EN 13924 (2006, hard bitumens) or NF EN 14023 (2010, polymer modified bitumens) Standards will be used.

Advantageously, the binder also comprises a polymer.

The “polymer” modifying the binder that is referred to here may be selected from natural or synthetic polymers. It is for example a polymer of the family of elastomers, synthetic or natural, and in an indicative and non-limiting manner:
random copolymers, multi-sequenced or star-shaped, of styrene and butadiene or isoprene in all proportions (in particular block copolymers of styrene-butadiene-styrene (SBS), of styrene-butadiene (SB, SBR for styrene-butadiene rubber), of styrene-isoprene-styrene (SIS)) or copolymers of the same chemical family (isoprene, natural rubber, etc.), optionally cross-linked in situ, in particular random copolymers, multi-sequenced or star-shaped, of styrene and butadiene or isoprene in all proportions,
copolymers of vinyl acetate and ethylene in all proportions,
copolymers of ethylene and esters of acrylic acid, methacrylic acid or maleic anhydride, copolymers and terpolymers of ethylene and glycidyl methacrylate and polyolefins, in particular polyethylene.

The polymer is advantageously selected from random copolymers, multi-sequenced or star-shaped, of styrene and butadiene or isoprene, copolymers of vinyl acetate and ethylene and polyethylene.

The polymer modifying the bitumen may be selected from recovered polymers, for example “rubber crumbs” or other rubber-based compositions reduced into pieces or into powder, for example obtained from used tyres or other polymer-based waste (cables, packaging, agricultural waste, etc.) or instead any other polymer commonly used for the modification of bitumens such as those cited in the Technical Guide written by the Association Internationale de la Route (AIPCR) and published by the Laboratoire Central des Ponts and Chaussées “Use of Modified Hydrocarbon-based binders, Special Bitumens and Bitumens with Additives in Road Pavements” (Paris, LCPC, 1999), as well as any mixture in any proportion of these polymers.

In the case of polymer from reclamation, in particular from waste, practically it could be added during the asphalt mix preparation, for example with the solid mineral fraction.

The polymer content in the binder advantageously varies from 2% to 20% by weight, more advantageously from 2% to 10% by weight, even more advantageously from 4% to 8% by weight, compared to the total weight of binder.

In the asphalt mix according to the invention, the binder content advantageously varies from 7.5% to 24% by volume, compared to the total volume of the asphalt mix, more advantageously from 11% to 23% by volume.

The asphalt mix used in the method according to the invention is workable.

The working temperature of the asphalt mix is advantageously below 130° C., more advantageously between 60° C. and 120° C., even more advantageously between 90° C. and 120° C.

Particularly suited asphalt mix has a workability, measured with a Nynas workability meter at the working temperature of the asphalt mix, of less than 350N, advantageously of less than 300 N, more advantageously of less than 250 N.

The asphalt mix according to the invention is deposited by spreading, for example with a paver or grader, then compacted. This compacting makes it possible to reduce the void content (V), after implementation and cooling, to less than 15%, more advantageously less than 10% (cf. NF EN 12697-5, -6, -8 Standards of 2012).

The asphalt mix used in the method according to the invention is also, advantageously, compact.

The compactness (C) of the asphalt mix formula measured by means of a gyratory shear press at 60 gyrations, according to the NF EN 12697-31 Standard of August 2007 is advantageously greater than 90%, more advantageously greater than 93%. The compactness may go up to 99.9%.

It will be recalled that C+V=100.

The hydrocarbon-based binder of the asphalt mix comprises an additive, having a melting point above 60° C. and below 130° C. The additive has a melting point above 60° C., advantageously above 80° C. The additive has a melting point below 130° C., advantageously below 120° C. Such an additive makes it possible to confer workability on the asphalt mix.

This additive makes it possible to reduce the viscosity of the binder to lower the manufacturing and implementation temperature of the asphalt mix while conserving the required mechanical properties, to improve the workability, to improve the compactness.

Advantageously, the additive is selected from a trigylceride of fatty acids. In particular, the fatty acid is selected from the group constituted of saturated fatty acids comprising from 12 to 30 carbon atoms, optionally substituted by at least one hydroxyl function or by a C₁-C₄ alkyl radical, in particular the fatty acid is selected from the group constituted of 12-hydroxy-octadecanoic acid, hexadecanoic acid, octadecanoic acid, 9,10-dihydroxy-octadecanoic acid, licosanoic acid, nonadecanoic acid, and mixtures thereof.

The workability additive is advantageously a trigylceride of fatty acids, the fatty acid being advantageously selected from the group defined previously. In particular, the additive comprises at least one triglyceride of which a molecule of fatty acid is constituted of 12-hydroxy-octadecanoic acid. Such an additive is for example described in the patent application EP 2 062 941.

The workability additive content will advantageously be between 1% and 6% by weight compared to the total weight of binder.

Furthermore, the asphalt mix is advantageously resistant to rutting, more advantageously with a percentage rutting after 30,000 cycles less than 7.5%, advantageously less than 5%.

The system is thereby suited to road traffic, including heavy traffic.

This rutting resistance results notably from the backbone of the granular fraction and the type of binder used.

If need be, to optimise the rutting resistance, advantageously a binder to which polymers have been added will be used, such as described previously.

When the asphalt mix includes a change of state workability additive, this additive is also going to make it possible to ensure good rutting resistance.

Polyphosphoric acid could also be added, as for example described in the patents WO2007/143016, WO2011/153267, WO2006/119354, FR 2 852 018.

The thermal conductivity of the asphalt mix is notably regulated by the type of aggregates.

The thermal conductivity, λ, of the asphalt mix is less than 1 W/m·K, advantageously it is less than 0.8 W/m·K, more advantageously less than or equal to 0.7 W/m·K. The thermal conductivity will be generally greater than 0.033 W/m·K.

Advantageously, the granular fraction of the asphalt mix comprises elements selected from light aggregates of specific gravity less than 2.6 t/m³, advantageously of specific gravity less than 1.6 t/m³.

Advantageously, all or part of the light aggregates are non-absorbent light aggregates having a water absorption coefficient less than 15%. Advantageously, the light and non-absorbent aggregates advantageously have a specific gravity between 1.1 t/m³ and 1.5 t/m³.

In addition to being light, the aggregates are advantageously non-absorbent. The property of “non-absorbent” is characterised by the measurement of the water absorption coefficient. According to the present invention, a non-absorbent aggregate is an aggregate that has a water absorption coefficient less than 15%, advantageously between 3% and 15%, more advantageously between 6% and 13%.

The water absorption coefficient is measured according to the standardised protocol described in the NF EN 1097-6 Standard (version June 2001 completed by the version of February 2006). The “water absorption coefficient” is the ratio of the increase in weight of a sample of aggregates to its dry weight, after passage in the oven, on account of the penetration of water into the pores accessible to water. The water absorption coefficient (in percentage of dry weight) (WA24) is calculated in accordance with the following equation:

$$WA 24 = \frac{100 \times ( M 1 - M 4 )}{M 4}$$

where:

M1 is the weight of saturated aggregates and superficially dry in air, in grams;
M4 is the weight of the test sample dried in the oven in air, in grams.

The weights M1 and M4 are measured according to the following protocol. The aggregates are immersed in water (ambient temperature, in particular 22±3° C.) for a sufficient time (advantageously 24 hours). The aggregates are next recovered, dried with a cloth, spread out in a single-granule layer and left exposed to free air but away from direct sunlight or any other source of heat until the visible films of water have disappeared. The aggregates (M1) are weighed. Next, the aggregates are transferred onto a plate and they are placed in an oven at a temperature of (110±5) ° C. up to constant weight (M4).

The water absorption coefficient is measured by the pycnometer method (the aggregates are loaded into a pycnometer filled with water).

These light and non-absorbent aggregates have furthermore good mechanical strength.

These aggregates advantageously have a void percentage above 50%, the pores being mainly closed pores. Thus, advantageously more than 90% by number of the pores are closed pores, advantageously more than 95%, and up to 100% of the pores are closed pores. These closed pores make it possible to ensure that the binder is not absorbed by the aggregates. Thus, the properties of the asphalt mix do not evolve more than those of a conventional asphalt mix. The void percentage is advantageously greater than 60%, more advantageously between 65% and 80%, even more advantageously between 65% and 75%. The void percentage may be determined by the geometric method, such as that described in the NF EN 12697-6 Standard of August 2012, or by a gamma densimetry method, such as that described in the NF EN 12697-7 Standard of June 2003.

These light and non-absorbent aggregates are advantageously expanded slate, in particular Mayenne expanded slate. More advantageously, these aggregates are the aggregates sold by the Granulats Expansés de la Mayenne Company under the tradename Granulex®.

The asphalt mix according to the invention may also comprise one or more additive(s). Additives may be added either to the binder, or to the aggregate, or to the asphalt mix.

The additives may also be used for aesthetic purposes, notably for a change of colour of the final road products. It may thus be a pigment, natural or not, such as iron oxide.

The invention also relates to a road surfacing comprising at least one layer of the asphalt mix according to the invention.

In particular, in the road surfacing, the layer of asphalt mix according to the invention constitutes an integration layer comprising pipes of a heat exchanger device.

Advantageously, the heat exchanger device integrated in the integration layer does not comprise any metal element. The pipes are advantageously made of polymer. Thus, the materials constituting the device (the pipes, the substrate and optional attachment elements, such as will be described hereafter) do not form an obstacle to a recycling, advantageously simultaneously, of the asphalt mix.

According to the NF P 98-149 Standard, June 2002:
“Recycling” is taken to mean the introduction, in a cycle for manufacturing hot or warm asphalt mix, of a given proportion of recovered asphalt mix (recycled asphalt mix). The recycling may be carried out in a plant or on site. In the latter case, it may be produced, either by thermo-recycling, or by cold milling, hot mixing of aggregates (milled materials) in a self-propelled material, and put back in place.
“Thermo-recycling” is taken to mean recycling in place by heating, splitting up, mixing of former asphalt mix with the necessary correctives (asphalt mix, aggregates and regeneration binder) and re-use of the mixture obtained.
“Milling” is taken to mean an operation of breaking up and removing bound materials using a rotating drum equipped with suitable tools (teeth, picks, knives).

The integration layer advantageously comprises less than 10%, more advantageously less than 5%, even more advantageously less than 1%, by volume of polymer per m³ of asphalt mix. Thus, this layer, after planing down during the reworking of the roadway, may be recycled and re-used without prior treatment.

The thickness of the integration layer advantageously varies from d to 10 cm, more advantageously from d to 8 cm, with d representing the diameter of the pipes.

The integration depth advantageously varies from 0.5 d to 1.5 d, more advantageously from 0.8 d to 1.2 d, with d representing the diameter of the pipes. To ensure planeness of the integration layer, it is desirable that not more than half of the diameter of the pipes juts beyond the layer. On the other hand, to ensure good thermal exchanges, the pipes have to be as close as possible to the surface.

The road surface according to the invention is characterised notably in that the pipes of a heat exchanger device are integrated in a layer of asphalt mix according to the invention, designated integration layer. This integration layer could support all traffic, including heavy traffic.

At least one heat-transfer fluid is going to be able to circulate in the pipes.

The road surface comprises, above the integration layer, at least one road surface layer:
i. adapted to traffic, from light traffic to heavy traffic, as a function of the compositions of the layers of the roadway
ii. that is going to be able to capture solar energy (in energy recovery mode) or which will be to heat up (in energy restitution mode).

The road could be of large surface area, which would provide a heat exchanger of large dimensions.

To optimise energy efficiency, the integration layer is close to the surface. In particular, the combined thickness of the layer(s) applied above said integration layer is less than 30 cm, advantageously less than 10 cm. It may for example vary from 2 cm to 30 cm, advantageously from 6 cm to 10 cm.

The road surface layer could comprise a multilayer constituted at the least of a binder course and a surface course.

In an alternative, the binder course has a thickness ranging from 4 cm to 14 cm, advantageously from 4 cm to 7 cm.

In an alternative, the surface course has a thickness ranging from 2 cm to 10 cm, advantageously from 5 cm to 7 cm.

For all the thicknesses, unless indicated otherwise, it is the thickness after compacting.

For certain applications, such as snow clearance from roadways, it is sought to orient as much as possible the energy transported by the heat-transfer fluid, circulating in the pipes, towards the surface. The insulating integration layer makes it possible to minimise any loss of heat elsewhere than to the surface.

As a complement, the road surfacing according to the invention may comprise, below the integration layer according to the invention, a layer of insulating materials.

These insulating materials may for example be a layer of asphalt mix comprising the light aggregates described previously, a cellular glass thermal insulation that comes in the form of plates of 60 cm×45 cm or 120 cm×60 cm format, and composed of rigid and hermetically sealed glass beads sold under the name FOAMGLAS®, polystyrene, etc.

Advantageously, the thermal conductivity, λ, of the layer of insulating materials is less than 1 W/m·K.

This layer of insulating materials may also fulfil the function of support layer.

The coating may also comprise an adhesion layer in order to improve adhesion between the insulating layer and the asphalt mix of the integration layer. It meets the specifications of the NF P 98-150-1 Standard, of June 2010.

An anchoring layer may be deposited on the integration layer. This anchoring layer makes it possible to improve the anchoring between the asphalt mix of the integration layer and the surface course or the binder course. It also makes it possible to protect the integration layer comprising the heat exchanger device.

The anchoring layer meets the specifications of the NF P 98-150-1 Standard, of June 2010.

The covering may also comprise above the integration layer or the anchoring layer, if need be, a coloured layer serving as visual warning.

The surface layers of the road surfacing constitute a thermal exchanger operating by capturing or restoring heat, as a function of the climate, of large surface area.

In operation, a heat-transfer fluid circulates in the pipes of the heat exchanger device. The heat-transfer fluid may be water or water containing glycol to reduce the freezing point and cold resistance. Water containing a non-harmful glycol of mono-propylene glycol type is preferred.

Additives, notably fungicidal and bactericidal additives, could be added to the heat-transfer fluid. Thus, a surface treatment of the pipes, such as an anti-oxygen barrier which could be unfavourable to adhesion, is avoided.

The pipes are connected to any suitable thermal system, including geothermal ground water at depth, a vertical geothermal probe, a heat pump, etc.

The invention also relates to a method for manufacturing a road surfacing according to the invention.

In particular, the invention relates to a method for manufacturing a road surfacing comprising a heat exchanger device, characterised in that the method comprises the following steps:
Applying on a surface at least one layer of the asphalt mix according to the invention to form an integration layer;
Integrating in the surface layer, preferably in its upper part, pipes of a heat exchanger device.

The asphalt mix is spread according to traditional methods, advantageously using a paver. Hot or warm asphalt mix could be used, with a preference for warm asphalt mix.

In particular, the working temperature of the asphalt mix is below 160° C., advantageously below 140° C., more advantageously below 130° C. In one embodiment, the working temperature of the asphalt mix is between 60° C. and 120° C., advantageously between 90° C. and 120° C.

In a first embodiment, the pipes of the heat exchanger device are indented into the integration layer before compacting the asphalt mix.

In this first embodiment, the method advantageously comprises the following steps:
a) spreading at a temperature below 160° C. the asphalt mix according to the invention, then
b) depositing pipes, said pipes having a crushing strength greater than 3000 N per linear metre of pipe at 100° C., a thermal expansion less than 200.10⁻⁶ K⁻¹ at 20° C. such that the pipes can be indented even in the absence of cooling means or pressure application means, then
c) indenting the deposited pipes into said integration layer by compacting said asphalt mix during the workability period of said asphalt mix, to form an integration layer comprising the pipes of a heat exchanger device, then
d) applying a surface layer there above for the road surface, in particular a surface course.

The method according to the invention makes it possible to integrate the pipes of the heat exchanger device in an integration layer during the production of the roadway integrating said integration layer.

The laying of the pipes simultaneously with the conception of the integration layer according to the invention makes it possible to ensure optimal contact between the pipes and the asphalt mix and thereby limit the presence of voids around the pipes.

The pipes are indented into the integration layer during the implementation period of the asphalt mix of the integration layer, before the end of compacting. This implementation period is defined by the workability of the asphalt mix.

The pipes are advantageously made of polymer. Indeed, it is desirable that the presence of the device in the road surface does not impact its recyclability. The polymer is selected as a function of the application temperature of the asphalt mix. A polymer having a melting or softening or glass transition point above the application temperature of the asphalt mix is chosen.

An important characteristic of these pipes is their crushing strength and their thermal expansion.

The crushing strength is the force obtained when the pipe is crushed in such a way that its external diameter is divided by two compared to its initial diameter.

The pipes have a crushing strength greater than 3000 N per linear metre of pipe at 100° C., advantageously greater than 4500 N, more advantageously greater than 10,000 N.

In particular, the pipes have a crushing strength between 3000 N and 100,000 N, advantageously between 4500 N and 100,000 N, more advantageously between 10,000 N and 100,000 N, per linear metre of pipe at 100° C.

The thermal expansion of the pipes is advantageously less than 200.10⁻⁶ K⁻¹ at 20° C., more advantageously less than 160.10⁻⁶ K⁻¹ at 20° C. The thermal expansion of the pipes is generally greater than 10.10⁻⁶ K⁻¹ at 20° C.

Indeed it has been noted, in a surprising manner, that in the asphalt mix according to the invention, when the pipes have such a crushing strength and such a thermal expansion, during the passage of the compactor, the pipes are indented in without being deformed and remain in place, even at the level of the bends. It is not necessary to fill them with a cooling liquid or any other means of thermal and/or mechanical protection and/or pressurisation of the pipes. This constitutes a significant economic advantage.

During the works, the ends of the pipe could remain open on the outside and the pipes will be simply filled with ambient air. It is thus possible to say that the pipes are laid empty.

In another alternative, water, advantageously at a temperature below 80° C., in particular ranging from 5° C. to 30° C., is made to circulate in the pipes before and/or during and/or after indentation, in particular during and/or just after indentation.

A successful indentation depends both on the workability of the asphalt mix and the crushing strength of the pipes. The greater the crushing strength of the pipes, the wider the tolerance threshold on the workability of the asphalt mix. The more workable the asphalt mix, the wider the tolerance threshold on the crushing strength of the pipes.

However, whatever the workable asphalt mix, the pipe has a crushing strength greater than 3000 N per linear metre of pipe at 100° C.

However, whatever the pipe, the minimum workability of the asphalt mix, measured with a Nynas workability meter at the working temperature of the asphalt mix, is less than 400N.

In one embodiment of the invention, the workability of the asphalt mix is between 300 N and 400 N. Then, the crushing strength of the pipes is greater than 4500 N per linear metre of pipe at 100° C.

In another embodiment of the invention, the workability of the asphalt mix is less than 300 N. Then, the crushing strength of the pipes is greater than 3000 N per linear metre of pipe at 100° C.

By the method according to the first embodiment of the invention, the pipes are not damaged, in particular deformed, by the rollers of the compactor and remain in position.

As is the practice, the compacting could be done in several passes.

Advantageously, no vibration is applied during compacting. Thus, advantageously, during step c) no vibration is applied.

For a same polymer, the rigidity of the pipes could be increased by increasing the wall thickness of the pipes.

Advantageously, the hot shrinkage of the pipes, measured according to the NF EN ISO 2505 Standard, of 2005, is less than 3% (in an oven, at 150° C. for 60 min), more advantageously less than 2%.

Another advantageous characteristic of the pipes is their adherence to the binder. It is considered that the pipes adhere to the bitumen when the following criterion is met: the pipes are smeared with a bitumen cationic emulsion with 65% of bitumen, during this operation if the emulsion does not form beads on the surface the adherence of the pipe is sufficient.

Such pipes adhere to the asphalt mix according to the invention and are thus more easily indented during compacting.

As an example of suitable polymer, high density polyethylene, polypropylene, block ethylene-propylene copolymers may be cited.

The pipes of the device advantageously have a diameter ranging from 5 mm to 30 mm. The pipes of the device advantageously have a wall thickness ranging from 1 mm to 5 mm.

The pipes are advantageously shaped beforehand to the desired geometry. Thus, the method according to the invention comprises a step in which a geometry is imposed on the pipes of the heat exchanger device before the deposition step b).

This step may be carried out beforehand in a factory or in a roadside workshop.

The imposed geometry may be any geometry making it possible to optimise thermal exchanges from the groundwater in operation, notably as a function of the desired applications. The method according to the invention makes it possible to indent the pipes whatever their curvature and thereby offer great flexibility on the geometry.

From a thermal viewpoint, exchanges are favoured when the indented pipes of the device form a pattern comprising N straight parallel lines substantially of same length and N−1 bends of which the angle of curvature may vary from 90° to 180°. The spacing between the parallel straight lines will be advantageously from 10 cm to 45 cm, more advantageously from 20 cm to 40 cm.

Before step b), the pipes could be free or positioned on a substrate.

When they are free, their geometry is advantageously imposed by shape memory.

Otherwise, the substrate serves to maintain the geometry and thereby facilitate the positioning of the pipes by supporting them.

The substrate is for example constituted of a synthetic geo-material, such as a geotextile or a geogrid, constituted of polymer, optionally bitumen, optionally mineral or organic fibres, woven or non-woven. The substrate is preferably permeable to water and to the bitumen emulsion to favour bonding. The fibres may in particular be glass fibres.

The substrate may remain in the integration layer or be removed after step b) or c).

The substrate remaining in the integration layer after indentation also makes it possible to reinforce the structure of said layer.

Advantageously, the materials constituting the substrate also enable a simultaneous recycling of the asphalt mix of the integration layer.

The device is advantageously conditioned in slabs or in rolls, more advantageously in rolls. Conditioning in slabs limits the dimensions to ensure delivery by lorry: the maximum dimensions of a cargo are a length of 12 m for a width of the order of 2.60 m.

It is preferably factory conditioned but it may be prepared in a roadside workshop.

Conditioning in slabs or rolls enables the laying of the device at the same time as the roadway is laid and makes it possible to ensure speeds compatible with the advancement of the roadworks. Advantageously, the speed of laying and indentation is greater than 2 m/min, more advantageously from 4 m/min to 10 m/min.

Conditioning in slabs or rolls also makes it possible to limit the elements introduced into the roadway in order to conserve the mechanical properties of the road.

A great advantage of the method according to the first embodiment of the invention is that compacting may be carried out directly, without requiring additional step(s) of protection of the pipes.

Moreover, the following steps of application above the integration layer of the surface layer(s) for road surface may be carried out directly, without requiring additional step(s) of protection of the pipes. Indeed, the integration layer makes it possible not only to maintain on the ground the desired geometry but also to protect the pipes.

The method according to this first embodiment:
Makes it possible to indent the pipes with the retained geometry, whatever the curvature of the pipes and thereby being able to comprise bends, loops, etc.
Does not leave void spaces between the pipes and the layer integrating them, thereby not requiring the addition of an adhesive layer to fill the void spaces and/or of a filling material;
Does not require cooling of the pipes by circulating a cooling agent, during the laying and/or the indenting and/or the subsequent steps of manufacturing the road surfacing including during the passage of plant machinery;
Does not require a pressurisation of the pipes during the laying and/or the indenting and/or the subsequent steps of manufacturing the road surfacing including during the passage of plant machinery;
Does not require a control of the angle of the pipes with the axis of the roller compactor;
Enables optimised heat exchange, notably by minimising the quantity of voids around the pipes of the heat exchanger;
Is economical, easy to implement, enabling:
   the installation at high speed of a heat exchanger
   to prepare a road surface which can support any traffic, including heavy traffic.

In a second embodiment, the pipes of the heat exchanger device are integrated in reservations created on the surface of the integration layer.

In this second embodiment, the method advantageously comprises the following steps:
a) spreading at a temperature below 160° C. of asphalt mix according to the invention to form an integration layer, then
b) creating reservations in the integration layer formed at the preceding step,
c) depositing pipes in the reservations created at the preceding step, then
d) if need be, application of a filling material, then
e) applying a surface layer there above for the road surface, in particular a surface course.

These reservations may be made:
hot, that is to say during the implementation period of the asphalt mix of the integration layer, before the end of compacting. Thus, they are created during the production of the road integrating said integration layer, or
cold, for example by milling.

To create hot reservations, it is possible to apply on the layer of asphalt mix a device D1 making it possible to create, by pressure, an imprint and thereby the reservations.

The device D1 may be a prefabricated shape, made of rigid or flexible material. The section is preferably circular and of dimensions close to the pipes to integrate, advantageously from 1.2 d to 1.5 d, d being the diameter of the pipes.

After formation of the hot reservation, the device D1 is removed.

The pressure on the device D1 may be mechanically assisted or assisted by road construction machinery such as a road compactor.

Alternatively, the hot reservation may be carried out by a device D2 equipped with a tool making it possible to create a reservation by displacement of the tool during the implementation period of the asphalt mix according to the invention.

D2 may be a notched drum making it possible by its movement and its weight to indent itself and to create the necessary reservation. Preferably the movement of D2 is a rotation.

D2 is designed so as not to damage the layer in which the indentation is carried out: It maintains, outside of the indentation notch, the compacting of the asphalt mix and it avoids the formation of rolls.

The pipes may be laid either during the implementation period of the asphalt mix or after the end of compacting: immediately at the end of compacting or several hours to several days after.

As in the first embodiment, the pipes are advantageously made of polymer.

When the pipes are laid during the implementation period of the asphalt mix, the polymer is selected as a function of the application temperature of the asphalt mix. A polymer having a melting or softening point above the application temperature of the asphalt mix is chosen.

In this second embodiment, the rigidity, the thermal shrinkage and the adherence to the bitumen of the pipes may be less critical. When the pipes are laid during the implementation period of the asphalt mix, it will however be preferred to use the pipes of the first embodiment. When the pipes are laid after, any type of pipe may be used.

In one embodiment, water, advantageously tempered, is made to circulate in the pipes, in particular after step c) and before step e).

A substrate may be used to facilitate the laying of the pipes. This substrate is advantageously such as described in the first embodiment.

Alternatively, or as a complement to the substrate, attachments could be used to maintain the pipes in place in the reservations.

As in the first embodiment, advantageously materials that do not impact the recycling of the road surface are used.

The creation of the hot reservations combined with laying of the pipes during the implementation period of the asphalt mix makes it possible to avoid step d), of adding a filling material. Indeed, the asphalt mix according to the invention is sufficiently workable and compact to fill the whole space.

The subsequent steps for the manufacture of the road surface may be carried out directly, without requiring additional step(s) of protection of the pipes.

If necessary, a filling product may be used to fill the interstices between the pipe and the reservations. As an example of suitable filling product, asphalt mix, bitumen emulsions, cold asphalt mix, cement based slurries, concretes, polymer materials may be cited. A bituminous binder based material will be preferred.

The filling product may make it possible to:
Embed the pipe in the reservation;
Ensure good roadway/pipe contact;
Dope thermal transfers.

The reservations may also be created cold, that is to say after the implementation period of the asphalt mix.

The cold reservations are advantageously made by a machining tool. Suitable site machinery is preferably a road milling machine of which the drum is designed to produce a slicing up of the roadway corresponding to the desired layout. This device makes it possible to form longitudinal or transversal grooved surfaces. The thickness of the grooves and the spacing between the grooves is defined by the layout and controlled by the drum. V-shaped, U-shaped and square, preferentially U-shape and square, groove profiles are possible along the orientation of the teeth. The looped returns, that is to say the bends of the pipes at 180°, is ensured by the planning down of a transversal strip, for example of width of 35 cm; or crown shaped grooves made by corers.

This machining may be carried out by a robot. The robot is equipped with a system making it possible to slice up the roadway. The execution of the reservation takes place from a digital model defining the path of the robot to produce the desired layout. The robot may also be controlled manually on site. In the case of the first method, and in order not to create the groove of 35 cm, the robot, may end the layout by machining the necessary bends.

In one embodiment, water, advantageously tempered, is made to circulate in the pipes, in particular after step c) and before step e).

A substrate may be used to facilitate the laying of the pipes. This substrate is advantageously such as described in the first embodiment.

Alternatively, or as a complement to the substrate, attachments could be used to maintain the pipes in place in the reservations.

As in the first embodiment, materials that do not impact the recycling of the road surface are advantageously used.

The subsequent steps for the manufacture of the road surface may be carried out directly, without requiring additional step(s) of protection of the pipes.

A filling product may be used to fill the interstices between the pipe and the reservations. As an example of suitable filling product, asphalt mix, bitumen emulsions, cold asphalt mix, cement based slurries, concretes, polymer materials may be cited. A bituminous binder based material will be preferred.

The filling product may make it possible to:
Embed the pipe in the reservation;
Ensure good roadway/pipe contact;
Dope thermal transfers.

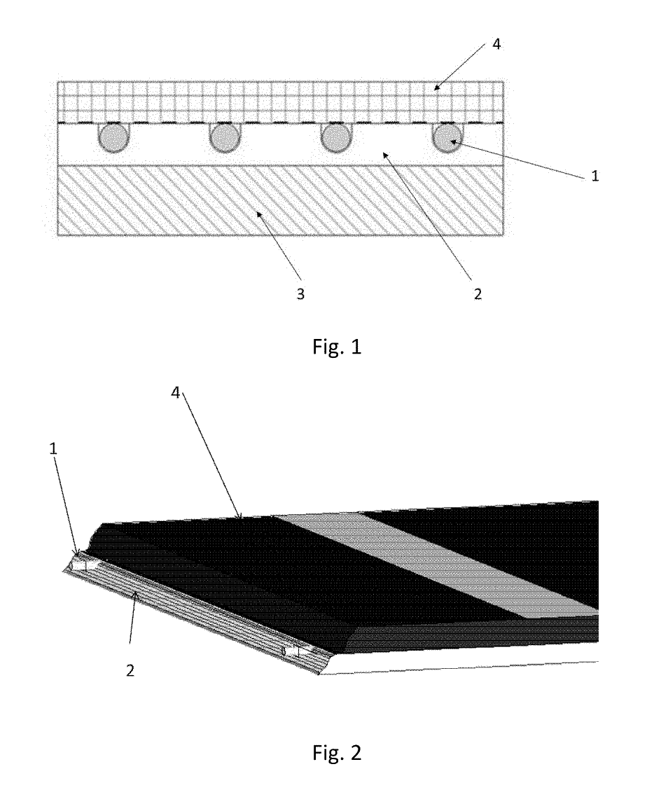

A sectional view of a road surfacing comprising on the surface a heat exchanger device is represented in FIG. 1.

The pipes 1, in which a heat-transfer fluid circulates, are indented into an integration layer 2. This integration layer 2 may be of high conductivity or insulating, depending on the nature of the granular fraction of the asphalt mix.

This integration layer 2 is deposited on a support layer 3, which could be an insulating layer. This support layer 3 is advantageously insulating when the integration layer 2 is not itself insulating. On the integration layer 2 is deposited a surface course 4. This surface course 4 has a high conductivity and constitutes the thermal exchanger that is going to capture solar energy or constitute the surface to heat, notably with a view to snow clearance or ice clearance from the roadway.

In FIG. 2 is represented the integration layer 2 comprising the pipes 1 on which a surface course 4 is deposited.

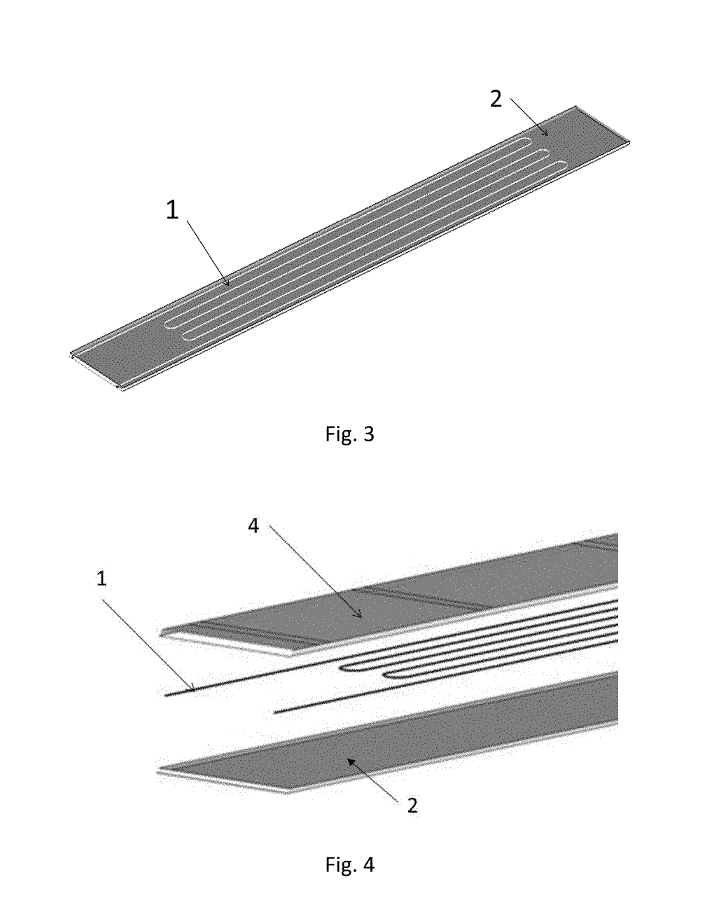

In FIG. 3, an example of possible geometry of the pipes 1 in the integration layer 2 is represented.

An exploded view of the integration layer 2, of the pipes 1 and of the surface course 4 is represented in FIG. 4.

### Protocols:

### Workability:

A workability test carried out according to the 98-258-1 Standard, of 2013, and suited
with a Nynas workability meter (version designated “large volume” and having a width of 30 cm, a length of 32 cm and a height of 13 cm)
to measuring a compactness of 75% (void content: 25%)
with a temperature below or equal to the working temperature (suitable temperature)

### Compactness:

The compactness of a formula is measured by means of a gyratory shear press (NF EN 12697-31 Standard of August 2007). A cylindrical test specimen of asphalt mix is compacted by combining a rotatory shear action and a resulting axial force applied by a power head.

This test makes it possible to determine the compactness of a test specimen for a given number of gyrations by measuring the associated test specimen height.

### Laboratory Indentation Test:

An asphalt mix is implemented on a compacting test bench according to the NF P 12697-33 Standard of September 2007, in a mould of dimensions 500 mm×180 mm at its working temperature. The compactness of the asphalt mix is taken to 75% by compacting with the roller. The pipes are positioned on the surface of the asphalt mix, transversally to the direction of circulation of the roller. They are maintained in place by a scotch tape placed in the direction of circulation of the roller. The pipes are indented into the asphalt mix by 6 to 10 passages of roller. The correct indentation of the pipe is assessed visually on two criteria: the shape of the imprint left by the pipe in the asphalt mix: this must be deep with a dimension close to the diameter of the pipe. The shape of the section of the pipe at the end of the test, said pipe must not be made oval.

### Thermal Conductivity Measurements:

To determine the thermal conductivity, a cylindrical test specimen (diameter 16 cm, thickness that can vary, usually 5 cm to 10 cm) of the material to be characterised, after a maturation time of 14 days, is subjected to a difference in temperature: 25° C. on one face, 10° C. on the other face. The measurement of the thermal flux passing through it, the difference in temperature between the faces and the thickness of the test specimen make it possible to determine the thermal conductivity of the material using the relationship:

ø=−λ·ΔT/L with:
λ the thermal conductivity expressed in W/m·K
ø the thermal flux traversing the test specimen expressed in W/m²
ΔT the difference in temperature at the edges of the test specimen expressed in ° C. or Kelvin
L The height of the test specimen

### Crushing:

To determine the crushing strength of the pipes, a sample of pipe, of a length between 5 cm and 10 cm is cut out. This sample is next placed for 2 hours in an oven at a temperature of 100° C. The crushing test is next carried out at the temperature of 100° C. The sample is next positioned, on its generating line, between the two parallel plates of a press, placed in a climatic chamber regulated to 100° C. The press imposes on the sample a displacement of 10 mm/min. The crushing strength value is determined when the diameter of the sample is divided by two compared to the initial diameter of the sample. It is expressed in Newtons per linear metre of pipe using the relationship:

Rt=Ft/Lt with:
Rt: crushing strength of the pipe
Ft: force developed to crush the pipe up to a reduction of half of its diameter
Lt: length of the sample subjected to the test

### Thermal Expansion:

it is measured according to the NF EN ISO 2505 Standard, of 2005.

### Adherence to Bitumen:

The pipes adhere to the bitumen when the following criterion is met: the pipes are smeared with a cationic emulsion of 50/70 bitumen dosed at 65% by weight of bitumen in accordance with the NF EN 13808 Standard of August 2013 using a brush. After one minute, a visual examination is carried out. If the emulsion does not form beads on the surface the adherence of the pipe is sufficient.

1. Hot or warm asphalt mix comprising a granular fraction and a hydrocarbon-based binder, wherein the granular fraction comprises:
4 to 15% by volume, compared to the total volume of the granular fraction, of fines, having a size less than 0.063 mm
15 to 80% by volume, compared to the total volume of the granular fraction, of sand, having a size between 0.063 mm and 2 mm
5 to 81% by volume, compared to the total volume of the granular fraction, of aggregates, having a size between 2 mm and 10 mm
and wherein the hydrocarbon-based binder comprises a workability additive, having a melting point above 60° C. and below 130° C.,
said asphalt mix being resistant to rutting, compact and workable, with a workability, measured with a Nynas workability meter at the working temperature of the asphalt mix, of less than 350N and insulating with a thermal conductivity, λ, of less than 1 W/m·K.

2. Asphalt mix according to claim 1, wherein the hydrocarbon-based binder is a 35/50 grade bitumen.

3. Asphalt mix according to claim 1, wherein the binder content varies from 7.5 to 24% by volume, compared to the total volume of the asphalt mix.

4. Asphalt mix according to claim 1, wherein their working temperature is below 130° C., advantageously between 60° C. and 120° C., more advantageously between 90° C. and 120° C.

5. Asphalt mix according to claim 1, wherein the workability, measured with a Nynas workability meter at the working temperature of the asphalt mix, is less than 300N, advantageously less than 250N.

6. Asphalt mix according to claim 1, wherein the compactness of the asphalt mix measured by means of a gyratory shear press at 60 gyrations, according to the NF EN 12697-31 Standard of August 2007, is greater than 90%

7. Asphalt mix according to claim 1, wherein the binder comprises from 1% to 6% by weight of said workability additive, compared to the weight of the binder.

8. Asphalt mix according to claim 1, wherein the workability additive is a trigylceride of fatty acids, the fatty acid being selected from the group constituted of saturated fatty acids comprising from 12 to 30 carbon atoms, optionally substituted by at least one hydroxyl function or by a C₁-C₄ alkyl radical, in particular the fatty acid is selected from the group constituted of 12-hydroxy-octadecanoic acid, hexadecanoic acid, octadecanoic acid, 9,10-dihydroxy-octadecanoic acid, icosanoic acid, nonadecanoic acid, and mixtures thereof.

9. Asphalt mix according to claim 1, wherein they are resistant to rutting with a percentage rutting after 30,000 cycles less than 7.5%, advantageously less than 5%.

10. Asphalt mix according to claim 1, wherein the binder comprises an elastomer, advantageously selected from random copolymers, multi-sequenced or star-shaped, of styrene and butadiene or isoprene in all proportions.

11. Asphalt mix according to claim 1, wherein the granular fraction comprises elements selected from light and non-absorbent aggregates having a specific gravity between 1.1 t/m³ and 1.5 t/m³ and a water absorption coefficient between 6% and 15%.

12. Road surfacing comprising at least one layer of the asphalt mix according to claim 1.

13. Road surfacing according to claim 12, wherein the layer of the asphalt mix constitutes an integration layer comprising pipes of a heat exchanger device.

14. Road surfacing according to claim 13, wherein the thickness of the integration layer varies from d to 10 cm, advantageously from d to 8 cm, with d representing the diameter of the pipes.

15. Road surfacing according to claim 13, comprising, above the integration layer, at least one road surface layer.

16. Method for manufacturing a road surfacing according to claim 13 comprising the pipes of a heat exchanger device, wherein the method comprises the following steps:
Application on a surface of at least one layer of the asphalt mix to form an integration layer;
Integration in the integration layer, preferably in its upper part, of pipes of a heat exchanger device.

17. Method according to claim 16, wherein the pipes of the heat exchanger device are indented into the integration layer before compacting the asphalt mix.

18. Method according to claim 16, wherein the pipes of the heat exchanger device are integrated in reservations created on the surface of the integration layer.
